(19) United States
(12) Patent Application Publication
(10) Pub. No.: US 2006/0101968 A1
(43) Pub. Date: May 18, 2006

(54) Table saw trunnion system

(76) Inventors: Chuck Baird, Verona, PA (US); Frederick Barbieri, White Oak, PA (US); Scott Cox, Kittanning, PA (US)

Correspondence Address: THE BLACK & DECKER CORPORATION, 701 EAST JOPPA ROAD, TW199, TOWSON, MD, 21286, US

(21) Appl. No.: 11/153,851

(22) Filed: Jun. 14, 2005

Related U.S. Application Data
(63) Continuation-in-part of application No. 11/084,218, filed on Mar. 18, 2005, now abandoned.
(60) Provisional application No. 60/554,159, filed on Mar. 18, 2004.

(51) Int. Cl. B23D 19/00

(52) U.S. Cl. 83/473

(57) ABSTRACT

A trunnion system for a table saw assembly. In an exemplary embodiment, the trunnion system includes a first mounting bracket and a second mounting bracket for mounting the trunnion system to a frame of the table saw assembly. Further, a first trunnion and a second trunnion for allowing a saw blade disposed within the table saw assembly to rotate to different bevel angles is included. The first trunnion being operationally coupled to the first mounting bracket and the second trunnion being operationally coupled to the second mounting bracket. The mounting of the first and second mounting brackets to the frame of the table saw assembly allows the trunnion system to rest upon the frame of the table saw assembly.

### CROSS-REFERENCE TO RELATED CASES

The present is a continuation-in-part under 35 U.S.C. § 120 of U.S. patent application Ser. No. 11/084,218 filed Mar. 18, 2005 which in turn claims the benefit under 35 U.S.C. § 119(e) of U.S. Provisional Application Ser. No. 60/554,159, filed Mar. 18, 2004 both of which are herein incorporated by reference in their entirety.

### FIELD OF INVENTION

The present invention generally relates to the field of power tools, and particularly to a trunnion system for a table saw.

### BACKGROUND OF THE INVENTION

Conventional “open-framed” style table saws include a variety of assemblies including a height adjustment assembly and a beveling assembly. The height adjustment assembly allows a saw blade disposed within the table saw to be raised and lower. The beveling assembly which includes a trunnion system allows the bevel angle of the saw blade to be changed. In order to get an accurate cross-cut with a table saw, the saw blade disposed within the table saw needs to be perfectly parallel with miter gauge slots which are present within the table saw. Such configuration allows an operator to vary the angle of cut on the workpiece. Intermittently, the saw blade alignment becomes skewed whereby the blade is no longer parallel with the miter gauge slots. The alteration of blade alignment may be due to a variety of reasons including vibrations caused by running the table saw. A non-parallel saw blade is problematic for it may result in inaccurate cutting.

Realignment of the saw blade so that it is once again parallel with the miter gauge slots may be accomplished by adjusting the trunnion system. Conventional trunnion systems are mounted to the bottom of the table or support surface of the table saw assembly. Such configuration is disadvantageous for a user may not easily gain access to the trunnion system which is necessary for adjustment. For example, a user must lift the support surface of the table saw assembly with the trunnion system attached in order to gain access to the trunnion system. Such task is extremely arduous due to the weight of the support surface and attached table saw components. Further, once a user has gained access to the trunnion system, the method of adjustment of such system is generally crude. For example, adjustment generally entails loosening fasteners that hold the trunnion system in place and then altering the trunnion system with respect to the miter gauge slot in the direction needed. Often a user employs a piece of scrap wood or even a hammer to reposition the trunnion system. Such method is not only time consuming and difficult to perform, but unsatisifactory for the method may not only cause the trunnion system to move, but other table saw system components as well.

Therefore, it would be desirable to provide a table saw with a system which allows a user to more easily reconfigure a saw blade which is out of alignment.

### SUMMARY OF INVENTION

Accordingly, the present invention is directed to a trunnion system for a table saw assembly. In an exemplary embodiment, the trunnion system includes a first mounting bracket and a second mounting bracket for mounting the trunnion system to a frame of the table saw assembly. Further, a first trunnion and a second trunnion are included for allowing a saw blade disposed within the table saw assembly to rotate to different bevel angles. The first trunnion being operationally coupled to the first mounting bracket and the second trunnion being operationally coupled to the second mounting bracket. The mounting of the first and second mounting brackets to the frame of the table saw assembly allows the trunnion system to rest upon such frame.

In specific aspects of the present invention, the frame includes more than one frame flange for supporting the trunnion brackets. In further embodiments, the first mounting bracket includes a first mounting bracket flange on a first end of the first mounting bracket and a second mounting bracket flange on a second end of the first mounting bracket. Moreover, the second mounting bracket includes a first mounting bracket flange on a first end of the second mounting bracket and a second mounting bracket flange on a second end of the second mounting bracket. In such embodiment, the first and second mounting bracket flanges on the first and second mounting brackets include apertures for fastening the brackets to the frame. Additionally, the first and second mounting bracket flanges on the first and second mounting brackets may be fastened to the more than one frame flange included on the frame of the table saw assembly. In further embodiments, the second mounting bracket flange within the first mounting bracket and the second mounting bracket flange of the second mounting bracket may include a raised portion and a divet for allowing the table of the table saw assembly to rest upon the frame of the table saw assembly.

In accordance with additional aspects of the present invention, a table saw assembly including a trunnion system is provided. In an exemplary embodiment, the table saw assembly includes a frame for supporting the table saw assembly. Further, a trunnion system is coupled to the frame for allowing a saw blade disposed within the table saw assembly to rotate to different bevel angles. In such embodment, the trunnion system includes a first mounting bracket and a second mounting bracket for the mounting of the trunnion system to the frame of the table saw assembly. In addition, a first trunnion is operationally coupled to the first mounting bracket and a second trunnion is operationally coupled to the second mounting bracket. The mounting of the trunnion system to the frame by the first and second mounting brackets allows the trunnion system to rest upon the frame.

### BRIEF DESCRIPTION OF THE DRAWINGS

The numerous advantages of the present invention may be better understood by those skilled in the art by reference to the accompanying figures in which:

FIG. 1 is an isometric view of a table saw assembly in accordance with an exemplary embodiment of the present invention, wherein the table saw assembly includes a trunnion system supported by a frame;

FIG. 2 is an exploded view of the trunnion system illustrated in FIG. 1, wherein the various components of the system are shown;

FIG. 3 is an exploded view of the trunnion system illustrated in FIG. 1, wherein the second trunnion mounting bracket is provided;

FIG. 4A is a side view of a trunnion system, wherein the trunnion system is mounted to the bottom of a table of a table saw assembly; and

FIG. 4B is a side view of a trunnion system in accordance with the present invention, wherein the second trunnion mounting bracket is mounted to and resting upon a frame of a table saw assembly.

### DETAILED DESCRIPTION OF THE INVENTION

Reference will now be made in detail to the presently preferred embodiments of the invention, examples of which are illustrated in the accompanying drawings.

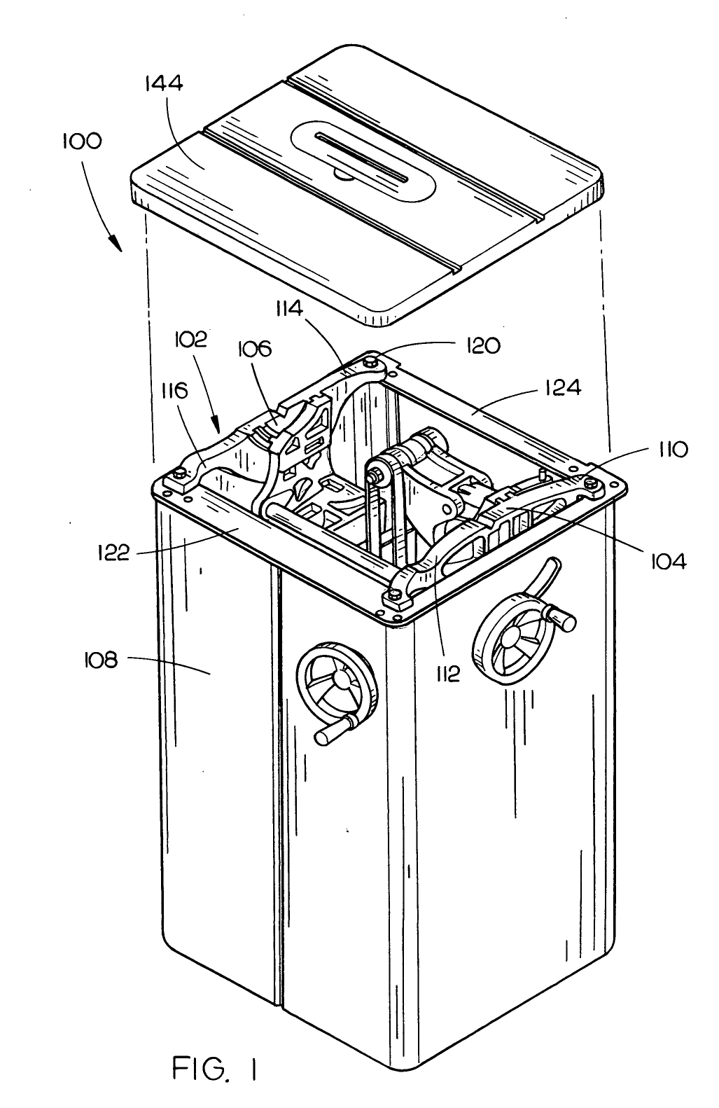

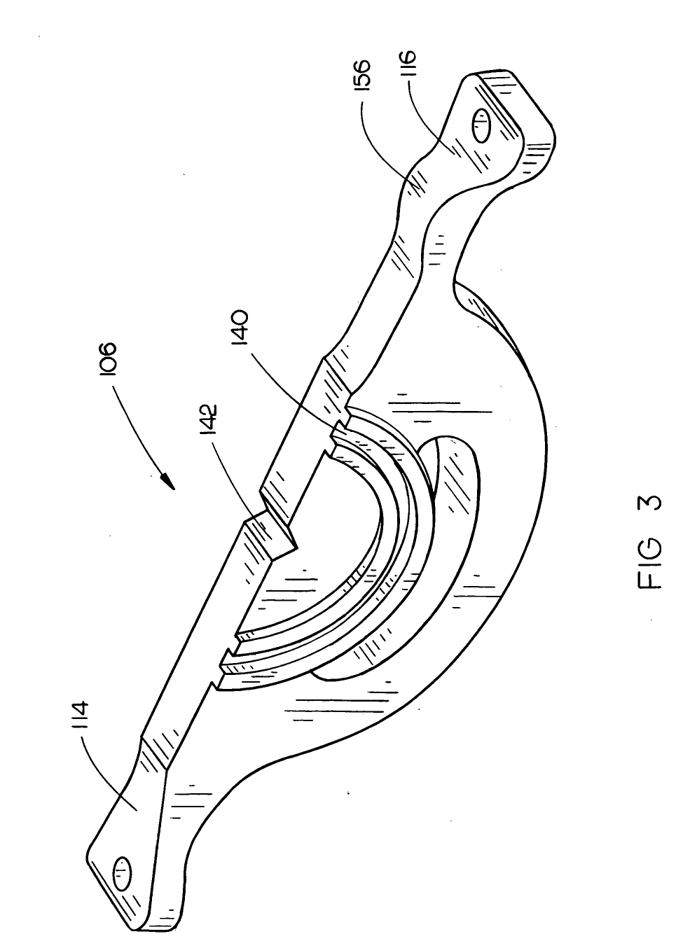

Referring generally now to FIGS. 1 through 4B, exemplary embodiments of the present invention are shown. In the instant invention, the trunnion system is mounted to the frame thereby permitting efficient alignment with miter gauge slots included within a table saw assembly. In an exemplary embodiment, in order to make adjustments, the user may simply adjust fasteners securing the table top surface to the frame of the table saw assembly. The table top surface may be positioned with respect to the frame and thus, the trunnion system which is connected to the frame. Such configuration does not require the user to remove the table top surface in order to make adjustments. The present invention provides a trunnion system with trunnion mounting brackets configured for operation in saw assemblies, such as the table saw assembly (frame saw) of FIG. 1. The configuration of the mounting brackets in a generally semi-circular shape and the inclusion of flanges provides such brackets with an increased length and weight over the standard quadrant shaped brackets employed with currently available trunnion systems. Thus, the trunnion system of the present invention may minimize transferred vibrations of the saw blade. This may in turn lead to an increased accuracy.

Referring specifically to FIG. 1, a table saw assembly 100 including an exemplary trunnion system 102 in accordance with the present invention is provided. In the present embodiment, the table saw assembly 100 includes the trunnion system 102 with a first or front trunnion mounting bracket 104 and a second or rear trunnion mounting bracket 106. Further, a frame 108 for supporting the table saw assembly 100 and for providing a mounting surface to which the trunnion system 102 may be mounted is included. In an advantageous embodiment, the first or front trunnion mounting bracket 104 includes a first flange 110 and a second flange 112. Moreover, the second or rear mounting bracket 106 includes a first flange 114 and a second flange 116. In addition, each flange includes an aperture 118 in which a fastener 120 may be placed. Such configuration allows the trunnion system 102 to be mounted to and resting upon the frame 108 of the table saw assembly 100.

In the instant embodiment, as illustrated in FIG. 1, the frame 108 includes a first flange 122 and a second flange 124. Each flange includes apertures which correspond to the respective apertures on the first trunnion mounting bracket 104 and the second trunnion mounting bracket 106. In use, the respective apertures are aligned and the trunnion system 102 is mounted to the flanges 122 and 124 of the frame 108 by an operator inserting a fastener 120 into such apertures and securing the assembly 102 with such fasteners 120 resulting in the first 104 and second 106 trunnion mounting brackets resting upon the frame 108. It is understood that flange number and design may vary including a single continuous flange, a flange being formed integral to material forming the frame, and the like. Further, it is contemplated that a variety of types of fasteners including screws, nuts, bolts, washers, and the like with the desired durability and strength may be employed to secure the first 104 and second 106 mounting brackets to the frame 108.

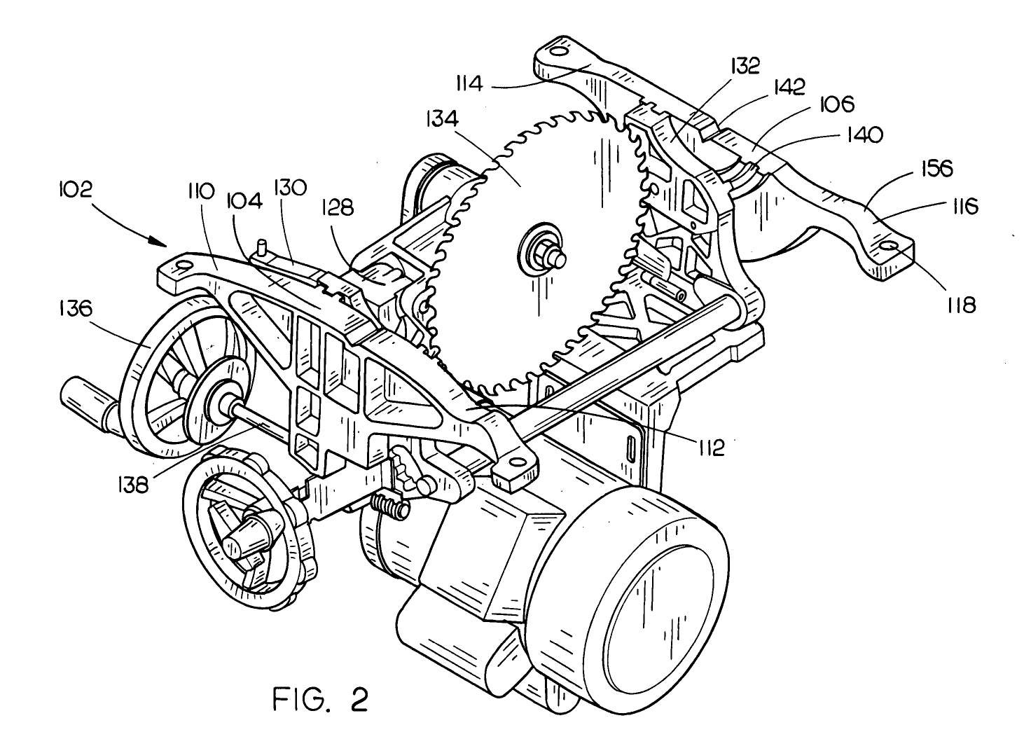

Referring specifically to FIG. 2, an exemplary embodiment of the trunnion system 102 illustrating the various components of the trunnions system 102. As illustrated in FIG. 2, the trunnion system 102 includes a first trunnion 130 and a second trunnion 132 for allowing a saw blade 134 disposed within the table saw assembly 100 to rotate to different bevel angles. In an advantageous embodiment, the bevel angle of a saw blade 134 is altered by rotating a hand wheel 136 coupled with a shaft 138. The shaft 138 may extend through the first or front trunnion mounting bracket 104 for supporting the shaft 138 and a bevel worm gear. In operation, the worm gear engages with a gear segment included on the first trunnion 130. Thus, as the hand wheel 136 is rotated the worm gear rotates the first trunnion 130 and thus, the saw blade 134, to the right or left, in relation to the first or front mounting bracket 104. It is contemplated that other mechanisms such as a planetary gear system, or the like, may be utilized to rotate the first trunnion 130.

With continued reference to FIG. 2, the second trunnion 132 is adjustably coupled with the second trunnion mounting bracket 106. In an exemplary embodiment, the second mounting bracket 106 includes a curvilinear groove 140 for supporting and engaging a corresponding mechanical interconnect on the second trunnion 132 such as a tab or rib. The curvilinear groove 140 is formed by two spaced apart ribs. In the current embodiment, the groove 140 is semi-circular. It is contemplated that the groove may be formed in the second trunnion 132 while the ribs or tab are formed in the second mounting bracket 106. In an advantageous embodiment, the rib or tab disposed within the second trunnion 132 slides within the semi-circular groove 140 present within the second trunnion mounting bracket 106 thereby allowing the second trunnion 132 to rotate through an arc with respect to the second mounting bracket 106. A substantially similar rib and groove assemblies may be included on the first trunnion mounting bracket 104 and the first trunnion 130 allowing for the first trunnion mounting bracket 104 and first trunnion 130 to be adjustably coupled in a manner similar to the second trunnion mounting bracket 106 and second trunnion 132 to permit beveling. It is understood that alternative systems for adjustably coupling the first trunnion 130 with the first trunnion mounting bracket 104 and the second trunnion mounting bracket 106 with the second trunnion 132 without departing from the scope and spirit of the present invention. Moreover, it is contemplated that the first trunnion 130 and the second trunnion 132 may be coupled to various component features of the table saw assembly 100.

Referring now to FIG. 2, the first 104 and second 106 trunnion mounting brackets of the trunnion system 102 are described. In an exemplary embodiment, as illustrated in FIG. 2, the first trunnion mounting bracket 104 includes a first flange 110 and a second flange 112. Moreover, the second or rear mounting bracket 106 includes a first flange 114 and a second flange 116. In the present embodiment, the first flange 110 of the first trunnion mounting bracket 104 is approximately the same length of the first flange 114 of the second trunnion mounting 106. Similarly, the second flange 112 of the first trunnion mounting bracket 104 is approximately the same length of the second flange 116 of the second mounting bracket 106. Such configuration allows the saw blade 134 to remain positioned exactly in the middle of the table or surface area of the table saw assembly whereby an arbor of the table saw assembly is allowed to be positioned off-centered.

In additional exemplary embodiments, as illustrated in FIG. 2, the second flange 112 of the first trunnion mounting bracket 104 and the second flange 116 of the second mounting bracket 106 are of a greater length compared to the first flange 110 of the first trunnion mounting bracket 104 and the first flange 114 of the second mounting bracket 106. Such configuration results in the trunnion system 102 being located off-center to account for the arbor assembly. Therefore, the saw blade 134 is in the center and allows for beveling.

In a further exemplary embodiment, the first mounting bracket 104 and the second mounting bracket 106 are contoured to accommodate a table or support surface including support ribs which reinforce the table top or support surface. For example, such ribs may form a lattice within the bottom surface of table top equal to a lip. In order for the table 144 to be rested upon the frame 108, a sufficient amount of clearance must be present between the ribs located on the bottom of the table 144 and the trunnion system 102. In an exemplary embodiment, a divet or recess 142 relative to the side directed toward a table or surface area of the table saw assembly is defined in the first trunnion mounting bracket 104 and the second trunnion mounting bracket 106. Each divet 142 in each of the mounting brackets 104 and 106 allows for the necessary clearance between the bottom of the table 144 or a rib disposed on the bottom of the table of the table saw assembly and the trunnion system 102 so that the table 144 may rest upon the frame 108.

In addition, as illustrated in FIG. 2, the first trunnion mounting bracket 104 and the second trunnion mounting bracket 106 include a raised portion 156 on the second flange 112 of the first mounting bracket 104 and the second flange 116 of the second mounting bracket. Such configuration provides the necessary clearance as well as support for the table 144 of the table saw assembly 100 so that the table 144 may rest upon the frame 108 of the table saw assembly 100.

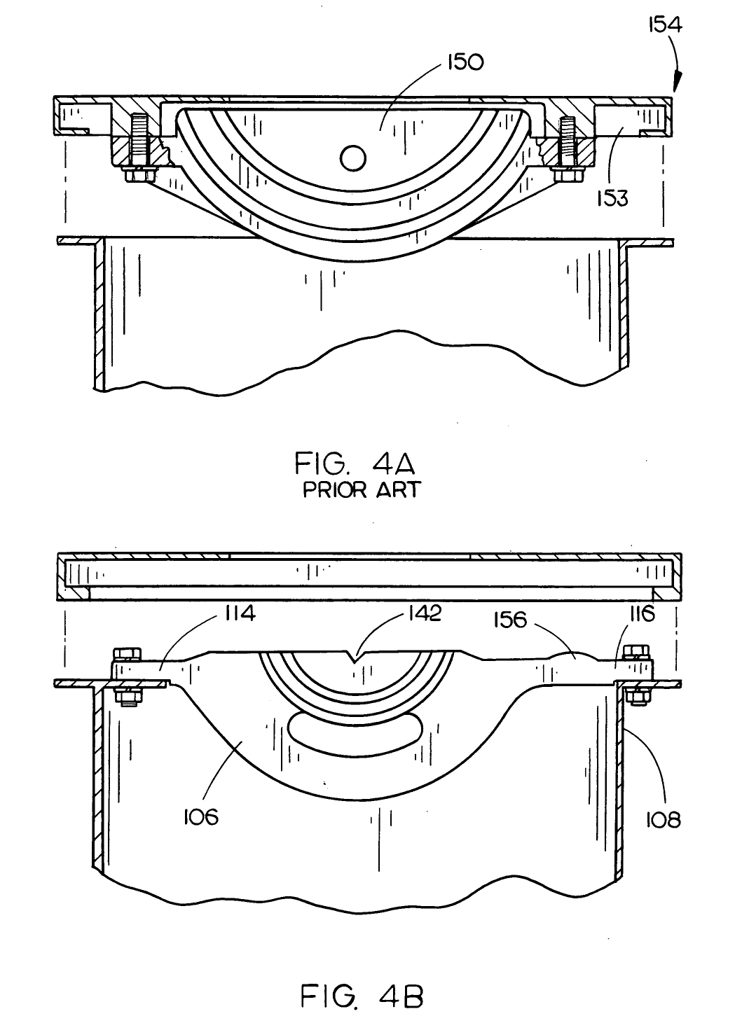

Referring specifically to FIGS. 4A and 4B, the manner in which a prior art trunnion system and one in accordance with the present invention are mounted to a table of a table saw assembly is shown. As illustrated in 4A, prior art trunnion systems mount the trunnion system to the table saw assembly by fastening a mounting bracket 150 to the bottom 153 of a table 154 of the table saw assembly. In a typical prior art trunnion system, fastening is accomplished by inserting a bolt through the mounting bracket into a threaded recess in the table 154 of the table saw assembly.

In contrast, as illustrated in FIG. 4B, a trunnion system in accordance with an exemplary embodiment of the present invention is supported by a frame of a table saw assembly permitting efficient adjustment of the trunnion system. Adjustment is efficient for a user may adjust the trunnion system by adjusting the position of one of the fasteners securing the system to the frame of the table saw. In an exemplary embodiment, such adjustment does not require the removal of the table.

In the present embodiment, as illustrated in FIG. 4B, the trunnion system rests upon the frame 108 of the table saw assembly. In an exemplary embodiment, fasteners may be employed to secure the trunnion system to the frame 108 by inserting the fasteners into apertures present within the mounting brackets and corresponding apertures included within flanges disposed within the frame 108. The fasteners may be efficiently accessed during adjustment as the fasteners are not attached to the table of the table saw assembly. In an advantageous embodiment, the fastener length is selected so that the fastener does not interfere with the table resting upon the frame 108. Such configuration allows a user to make adjustments efficiently, whereby a user may simply loosen or tighten the fasteners which secure the trunnion system to the frame 108 and thus, align the trunnion system in a desired position.

It is contemplated that the table or surface area of the table saw assembly may include recesses which allow the table to be engaged with the cabinet frame on which the trunnion system is mounted. It is further contemplated that the table or surface area may be attached to a flange included within the frame allowing the table to be secured to the frame. For example, in an exemplary embodiment, in order to make adjustments, the user may simply adjust fasteners securing the table top surface to the frame of the table saw assembly. The table top surface may be positioned with respect to the frame and thus, the trunnion system which is connected to the frame. Such configuration does not require the user to remove the table top surface in order to make adjustments. It is to be understood that additional configurations may be employed to allow for a user to adjust the position of the trunnion system. For instance, a user may adjust the system by first removing fasteners securing the table to an outer flange positioned extending beyond the perimeter of the frame of the table saw assembly. After removing the fasteners securing the table or surface area to the frame, the table may be removed and the fasteners securing the trunnion system to the frame may then be accessed. The trunnion system may be positioned with respect to the frame and thus, the table which is connected to the frame.

During use, a user may realign a saw blade disposed within a table saw so that the saw blade is once again parallel with the miter gauge slots present within a table saw by adjusting the trunnion system. In accordance with an exemplary embodiment of the present invention, adjustment of the trunnion system is accomplished by the user adjusting fasteners securing the table top surface to the frame of the table saw assembly. The table top surface may be positioned with respect to the frame and thus, the trunnion system which is connected to the frame. Such configuration does not require the user to remove the table top surface in order to make adjustments. In an additional embodiment, realignment may be accomplished by the user removing the table or surface area of the table saw assembly off of the frame. Fasteners securing the trunnion system brackets to the frame are to be loosen and the saw blade is to be re-aligned with the miter gauge slots by adjusting the position of the trunnion system. After re-positioning the trunnion sytem, fasteners which engage such system are re-secured, thus securing the trunnion system to the frame. The table or surface area is then aligned with the trunnion system and the frame.

It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A trunnion system for a table saw assembly, comprising:
a first mounting bracket and a second mounting bracket configured for mounting of the trunnion system to a frame of the table saw assembly; and
a first trunnion pivotally coupled to the first mounting bracket and a second trunnion pivotally coupled to the second mounting bracket for allowing a saw blade disposed within the table saw assembly to rotate to different bevel angles,
wherein the mounting of the first and second mounting brackets to the frame of the table saw assembly allows the trunnion system to rest upon the frame of the table saw assembly.

2. The trunnion system for a table saw assembly of claim 1, wherein the frame includes at least two flanges for providing a support surface on which the trunnion system rests.

3. The trunnion system for a table saw assembly of claim 1, wherein the first mounting bracket includes a first flange on a first end of the first mounting bracket and a second flange on a second end of the first mounting bracket; the second mounting bracket includes a first flange on a first end of the second mounting bracket and a second flange on a second end of the second mounting bracket.

4. The trunnion system for a table saw assembly of claim 3, wherein the first and second flanges on the first and second mounting brackets include apertures for fastening the brackets to the frame.

5. The trunnion system for a table saw assembly of claim 4, wherein the first and second flanges on the first and second mounting brackets are fastened to at least two flanges included on the frame of the table saw assembly.

6. The trunnion system for a table saw assembly of claim 3, wherein the second flange within the first mounting bracket and the second flange of the second mounting bracket include a raised portion allowing a table of the table saw assembly to rest on the frame.

7. The trunnion system for a table saw assembly of claim 1, wherein the first and second mounting brackets defines a divet for allowing the first and second mounting brackets to be contoured to a bottom of a table of a table saw assembly, the bottom including support rib.

8. A trunnion system for a table saw assembly, comprising:
a first mounting bracket and a second mounting bracket configured for the mounting of the trunnion system to a frame of the table saw assembly, the frame including more than one flange for providing a surface area to rest the trunnion system; and
a first trunnion pivotally coupled to the first mounting bracket and a second trunnion pivotally coupled to the second mounting bracket for allowing a saw blade disposed within the table saw assembly to rotate to different bevel angles,
wherein the mounting of the first and second mounting brackets to the more than one flange included on the frame of the table saw assembly allows the trunnion system to rest upon the frame.

9. The trunnion system for a table saw assembly of claim 8, wherein the first mounting bracket includes a first flange on a first end of the first mounting bracket and a second flange on a second end of the first mounting bracket; the second mounting bracket includes a first flange on a first end of the second mounting bracket and a second flange on a second end of the second mounting bracket.

10. The trunnion system for a table saw assembly of claim 9, wherein the first and second flanges on the first and second mounting brackets include apertures for fastening the brackets to the flanges included on the frame.

11. The trunnion system for a table saw assembly of claim 10, wherein the first and second flanges on the first and second mounting brackets are fastened to the more than one flanges included on the frame of the table saw assembly by a plurality of fasteners selected from the group consisting of screws, bolts, nuts, and washers.

12. The trunnion system for a table saw assembly of claim 9, wherein the second flange within the first mounting bracket and the second flange of the second mounting bracket include a raised portion allowing a table of the table saw assembly to rest on the frame.

13. The trunnion system for a table saw assembly of claim 8, wherein the first and second mounting brackets defines a divet for allowing the first and second mounting brackets to be contoured to a bottom of a table of a table saw assembly, the bottom including support rib.

14. A table saw assembly including a trunnion system, comprising:
a frame for supporting the table saw assembly; and
a trunnion system coupled to the frame for allowing a saw blade disposed within the frame table saw assembly to rotate to different bevel angles, the trunnion system including:
a first mounting bracket and a second mounting bracket for mounting of the trunnion system to the frame of the table saw assembly; and a first trunnion being pivotally coupled to the first mounting bracket and a second trunnion being pivotally coupled to the second mounting bracket,
wherein the mounting of the trunnion system to the frame by the first and second mounting brackets allows the trunnion system to rest upon the frame.

15. The table saw assembly of claim 14, wherein the frame includes at least two flanges for providing a support surface on which the trunnion system rests.

16. The table saw assembly of claim 14, wherein the first mounting bracket includes a first flange on a first end of the first mounting bracket and a second flange on a second end of the first mounting bracket; the second mounting bracket includes a first flange on a first end of the second mounting bracket and a second flange on a second end of the second mounting bracket.

17. The table saw assembly of claim 16, wherein the first and second flanges on the first and second mounting brackets include apertures for fastening the brackets to the frame.

18. The table saw assembly of claim 17, wherein the first and second flanges on the first and second mounting brackets are fastened to the frame of the table saw assembly by at least two flanges included on the frame.

19. The table saw assembly of claim 16, wherein the second flange within the first mounting bracket and the second flange of the second mounting bracket include a raised portion allowing a table of the table saw assembly to rest on the frame.

20. The table saw assembly of claim 16, wherein the first and second mounting brackets defines a divet for allowing the first and second mounting brackets to be contoured to a bottom of a table of a table saw assembly, the bottom including support rib.
